(19) United States
(12) Patent Application Publication
(10) Pub. No.: US 2008/0272036 A1
(43) Pub. Date: Nov. 6, 2008

(54) Oil filter by-pass adapter

(76) Inventor: James Winnicki, Porterville, CA (US)

Correspondence Address: Charlette M. Crissman; Klein, DeNatale, Goldner;Rosenlieb & Kimball, LLP, 2nd Floor, 4550 California Avenue, Bakersfield, CA, 93309, US

(21) Appl. No.: 12/077,837

(22) Filed: Mar. 18, 2008

Related U.S. Application Data
(60) Provisional application No. 60/918,631, filed on Mar. 19, 2007.

(51) Int. Cl. B01D 27/10

(52) U.S. Cl. 210/133

(57) ABSTRACT

An oil filter by-pass adapter for placement between an internal combustion engine block and a spin-on type oil filter comprising a wafer plate having a first face adapted to contact the engine block, and a second face adapted to contact the oil filter. The second face has a peripheral wall to retain the oil filter. A central through passage extends through the wafer and provides clearance for the oil to enter and exit the oil filter. There is a choked flow oil conduit from the input oil stream having at least one oil transfer passage which takes oil from before the oil filter and passes it to an oil transfer channel. The oil filter by-pass adapter can be an ultra high molecular density plastic or aluminum. The oil filter by-pass adapter oil transfer passages are between 1/64- 7/64 inches in diameter and the oil transfer channel is between 3/64-¼ inches in diameter.

### CROSS-REFERENCE TO RELATED APPLICATIONS

This application claims the benefit of U.S. Provisional Application No. 60/918,631, filed Mar. 19, 2007 for which this inventor claims domestic priority, which is hereby incorporated by reference.

### BACKGROUND OF THE INVENTION

The disclosed device relates to an oil filter by-pass adapter for use in connection with an internal combustion engine block and a spin-on type oil filter of an oil filtration system. The oil filter by-pass adapter has particular utility in connection with diverting a choked flow oil stream from the oil filtration system at a point prior to the primary oil filter through use of a minimal thickness wafer that does not interfere with the threaded junction of the engine block and the primary oil filter.

The use of by-pass filters is known. For example, U.S. Pat. No. 4,752,387 to Thomas discloses a method and means for installing a by-pass filter that sends a portion of the oil flow from a primary filter to an auxiliary filter. However, the Thomas '387 patent does not have the structure of the present device as it requires puncturing the wall of the primary oil filter.

Similarly, U.S. Pat. No. 5,443,138 to Bedi et al. discloses a universal sandwich adapter and threaded nipple for attaching same that fits between the engine block and the oil filter. However, the Bedi '138 patent does not have the structure of the present device, as it requires an additional nipple adapter.

Additionally, U.S. Pat. No. 4,452,695 to Schmidt discloses a full-flow and by-pass filter conversion system for internal combustion engines that fits between the engine block and the oil filter. However, the Schmidt '695 patent does not have the structure of the present device, as it requires an additional nipple adapter.

The above-described devices they do not describe an oil filter by-pass adapter that provides for the advantages of the disclosed device; therefore, a need exists for an improved oil filter by-pass adapter that doesn't involve damaging the integrity of the primary oil filter and also doesn't require an additional nipple adapter.

### SUMMARY OF THE INVENTION

The disclosed device meets the need described above. The general purpose of the disclosed device, which will be described subsequently in greater detail, is to provide a new and improved oil filter by-pass adapter.

To attain this, the disclosed device essentially comprises an oil filter by-pass adapter for placement between an internal combustion engine block and a spin-on type oil filter of an oil filtration system. The oil filtration system comprises an oil pump, a central oil reservoir, a primary oil filter, an input oil stream from the oil pump leading into the primary oil filter, and an output oil stream leading out of the primary oil filter into the engine block. The oil filter by-pass adapter comprises a wafer plate having an outer wall, a first face adapted to contact and seal against the engine block and a second face adapted to contact and seal against the spin-on type oil filter. The second face has a peripheral wall, or register, that serves to center and engage the oil filter. The wafer plate thickness will vary by application, but in any case is not thick enough to interfere with the seal of the oil filter to the engine block. A central through passage extends through the wafer plate from the first face to the second face thereby defining an internal wall, and provides clearance for the input oil stream to enter the spin-on type oil filter and the output oil stream to exit the spin-on type oil filter and enter the engine block.

There is a choked flow oil conduit having one or more oil transfer passages and an oil transfer channel, which function together to remove the choked flow oil stream from the area where the input oil stream enters the primary oil filter. This choked flow oil stream is sent to an auxiliary filter and then returned to the central oil reservoir. The oil transfer passage has a first end and a second end, the first end being in fluid communication with the input oil stream. The oil transfer channel has a first end and a second end, the oil transfer channel first end connecting with the oil transfer passage second end. The oil thus flows through the oil transfer passage and into the oil transfer channel. The diameter of the oil transfer channel limits the volume of oil that is transferred to the auxiliary oil filter. The volume of oil transferred to the auxiliary filter is limited so as to not interfere with the oil pressure of the oil flowing to the engine block.

The oil flows to the auxiliary filter, which filters out smaller sized particles than are removed by the primary filter. Although the flow rate through the secondary filter is lower than the flow rate through the primary oil filter, the auxiliary filter will, over time, filter the entire volume of oil in the central oil reservoir. Most primary oil filters will remove particles larger than 20 microns from the oil stream. However, with the addition of an auxiliary filter it is possible to remove particles down to 2 microns from the oil stream. This extra filtration reduces the load on the engine components during a cold start, as more particles in the oil stream have been removed from the oil stream and are no longer present to provide friction. This reduction in particle size also assists in reducing friction during normal operation.

The oil filter by-pass adapter can comprise an ultra high molecular density plastic or aluminum. The oil filter by-pass adapter oil transfer passages are in the range of 1/64 inches to 7/64 inches in diameter, and the oil transfer channel is in the range of 3/64 inches to ¼ inches in diameter, although the exact diameter will be chosen to suit the application.

Thus has been broadly outlined the more important features of the oil filter bypass adapter so that the detailed description thereof that follows may be better understood and in order that the present contribution to the art may be better appreciated.

Those skilled in the art will appreciate that the conception upon which this disclosure is based may readily be utilized as a basis for the design of other structures, methods and systems for carrying out the several purposes of the oil filter by-pass adapter. It is therefore important that the claims be regarded as including such equivalent constructions insofar as they do not depart from the spirit and scope of the disclosed device. It is also to be understood that the phraseology and terminology employed herein are for purposes of description and should not be regarded as limiting.

These together with additional objects of the oil filter by-pass adapter, along with various novel features that characterize the invention are particularly pointed out in the claims forming a part of this disclosure. For better understanding of the oil filter by-pass adapter, its operating advantages and specific objects attained by its uses, refer to the accompanying drawings and description.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an exploded perspective view of the oil filter by-pass adapter constructed in accordance with the principles of the disclosed device.

FIG. 2 is a cross-sectional view of the oil filter by-pass adapter, taken essentially along the lines 2-2 of FIG. 1.

FIG. 3 is a partial exploded cross-sectional view of the oil filter by-pass adapter, taken essentially along the lines 3-3 of FIG. 1.

FIG. 4 is a partial cross-sectional view of the oil filter by-pass adapter, with the removed section taken essentially along the lines 3-3 of FIG. 1.

FIG. 5 is a schematic of the oil filter by-pass adapter in use between a primary oil filter and an engine block.

FIG. 6 is a cross-sectional schematic of a primary oil filter.

FIG. 7 is a block diagram of an oil filtration system.

FIG. 8 is a block diagram of an oil filtration system using the disclosed device.

The same reference numbers refer to the same parts throughout the various figures.

### DETAILED DESCRIPTION OF THE EMBODIMENT

Referring now to the drawings, the oil filter by-pass adapter of the disclosed device is shown and generally designated by the reference numeral 10.

In FIG. 1, a new and improved oil filter by-pass adapter 10 of the disclosed device is illustrated and will be described. More particularly, the oil filter by-pass adapter 10 comprises a wafer plate with an outer wall 12 and a second face 16. The second face 16 has a peripheral wall 18 that centers a spin-on type primary oil filter. There is a central through passage 20 extending through the wafer plate, and the central through passage 20 defines an inner wall 22. A choked flow oil conduit 24 is an integral part of the outer wall 12.

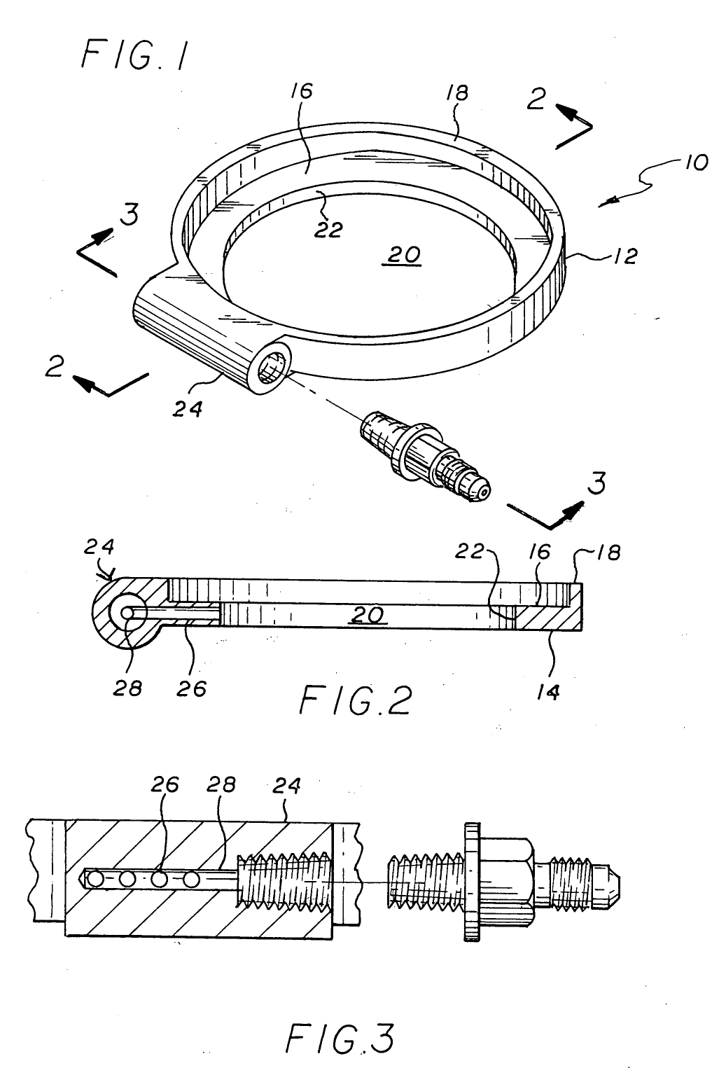

FIG. 2 is a cross-sectional view of the oil filter by-pass adapter, and shows the outer wall 12, the first face 14, the second face 16, and the peripheral wall 18. The central through passage 20 extends through the wafer plate from the first face 14 to the second face 16. The inner wall 22 defined by the central through passage 20 can be seen. The choked flow oil conduit 24 has at least one oil transfer passage 26, and the oil transfer passage 26 begins at the inner wall 22. The choked flow oil conduit also has an oil transfer channel 28. The oil transfer channel 28 is connected with the oil transfer passage 26, and the oil stream is from the oil transfer passage 26 to the oil transfer channel 28. The oil filter by-pass adapter oil transfer passages 26 are in the range of 1/64 inches to 7/64 inches in diameter, and the oil transfer channel 28 is in the range of 3/64 inches to ¼ inches in diameter, although the exact diameter will be chosen from these ranges to divert sufficient oil flow without inducing a drop in oil pressure.

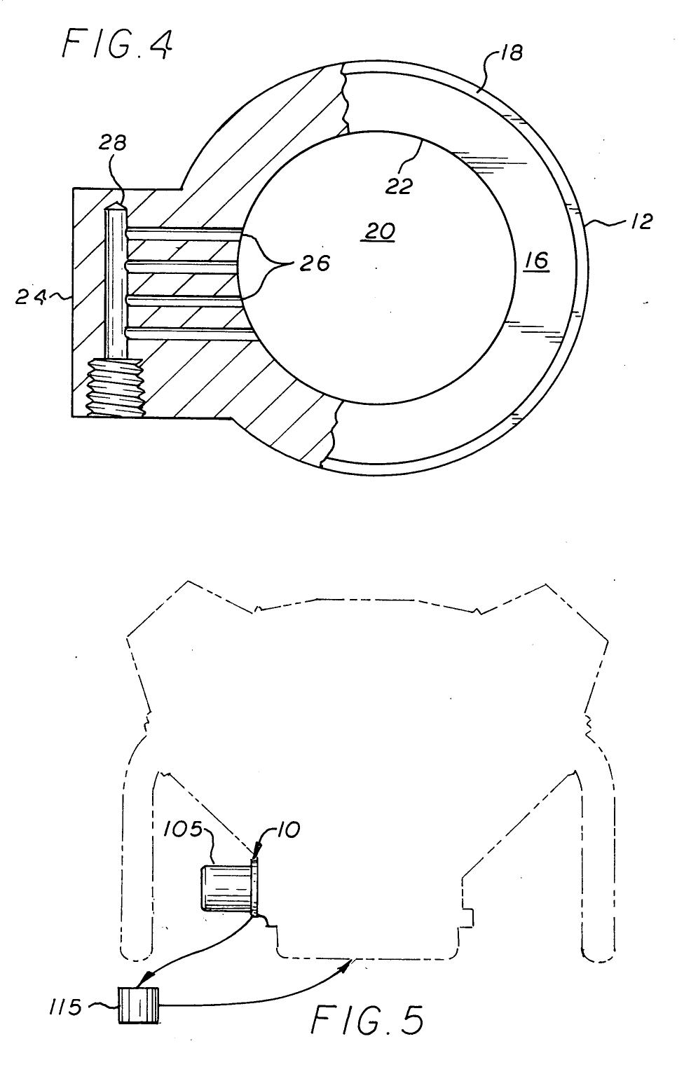

In FIG. 3 a partial cross-sectional view of the oil filter by-pass adapter and shows the choked flow oil conduit 24, oil transfer passage 26, and oil transfer channel 28. The volume of transferred oil is kept to a choked flow oil stream through limiting the diameter of the oil transfer channel 28. The oil filter by-pass adapter oil transfer passages are in the range of 1/64 inches to 7/64 inches in diameter, and the oil transfer channel is in the range of 3/64 inches to ¼ inches in diameter.

Shown in FIG. 4 is a break-away cross-sectional view of the oil filter by-pass adapter and the removed section is taken essentially along the lines 3-3 of FIG. 1. The outer wall 12, second face 16, and the peripheral wall 18 of the second face 16 are shown. The peripheral wall 18 centers a spin-on type primary oil filter. A central through passage 20 extends through the wafer plate, and the central through passage 20 defines an inner wall 22. A choked flow oil conduit 24 is located on the outer wall 12, and the choked flow oil conduit 24 has an oil transfer passage 26 and an oil transfer channel 28.

FIG. 5 is a schematic of the oil filter by-pass adapter 10 in use between a primary oil filter 105 and an engine. The oil is diverted from the region of oil transfer from the engine to the primary oil filter 105. The oil flows to an auxiliary filter 115 and after filtration is then sent back into the central oil reservoir.

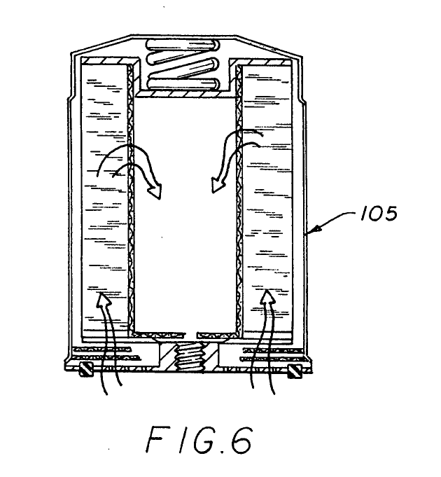

In FIG. 6 a cross-sectional schematic of a primary oil filter 105 is shown, with the input oil stream leading into the media of the primary oil filter, and an output oil stream exiting the media of the primary oil filter 105.

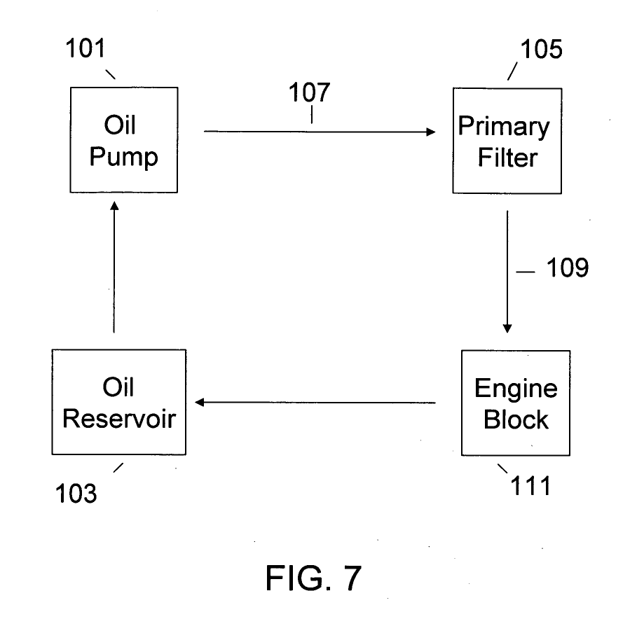

FIG. 7 shows a block diagram of an oil filtration system. The oil filtration system has an oil pump 101 that takes the oil stored in the central oil reservoir 103 and sends it to a primary oil filter 105 via an input oil stream 107 from the oil pump 101. The oil exits the primary oil filter 105 via an output oil stream 109 that leads out of the primary oil filter 105 and into the engine block 111 for dispersal through an internal engine lubrication system.

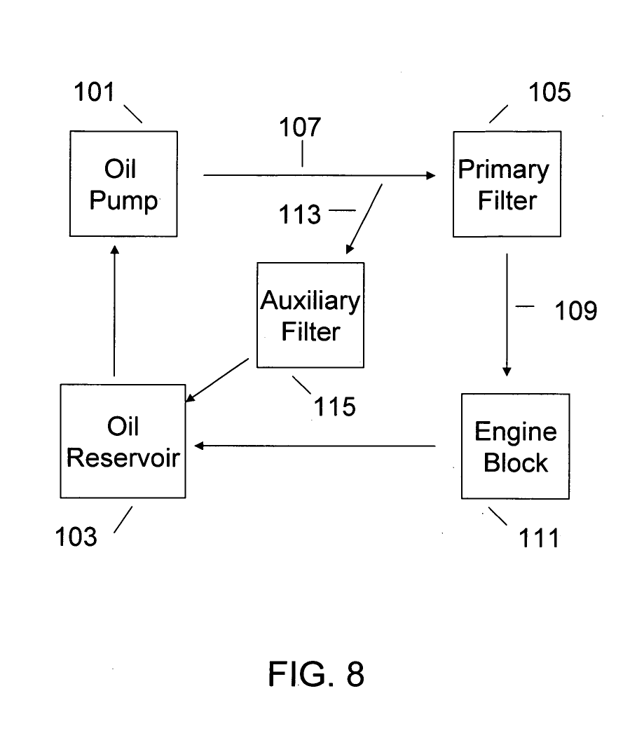

FIG. 8 is a block diagram of an oil filtration system using the disclosed device. The oil filtration system has an oil pump 101 that takes the oil stored in the central oil reservoir 103 and sends it to a primary oil filter 105 via an input oil stream 107 from the oil pump 101. The oil exits the primary oil filter 105 via an output oil stream 109 that leads out of the primary oil filter 105 and into the engine block 111 for dispersal through an internal engine lubrication system. The choked flow oil stream 113 is split from the input oil stream 107 before the input oil stream 107 reaches the primary oil filter 105. The choked flow oil stream 113 enters the auxiliary filter and the filtered oil is returned to the central oil reservoir 103.

The oil filter by-pass adapter 10 is placed between an internal combustion engine block 111 and a spin-on type primary oil filter 105 of an oil filtration system. The oil filtration system comprises an oil pump 101 that removes oil from a central oil reservoir 103 and sends the oil to a primary oil filter 105 via an input oil stream 107. The input oil stream 107 leads from the oil pump 101 into the primary oil filter 105 and the output oil stream 109 leads out of the primary oil filter 105 into the engine block 111. The oil filter by-pass adapter 10 diverts a choked flow oil stream 113 to an auxiliary filter 115, and this diverted stream is then returned to the central oil reservoir 103.

The oil filter by-pass adapter 10 comprises a wafer plate having an outer wall 12, a first face 14 adapted to contact and seal against the engine block 111 and a second face 16 adapted to contact and seal against a spin-on type primary oil filter 105. The second face 16 has a peripheral wall 18. There is a central through passage 20 extending through the wafer plate from the first face 14 to the second face 16 that provides clearance for the input oil stream 107 to enter the spin-on type primary oil filter 105 and the output oil stream 109 to exit the spin-on type primary oil filter 105. The central through passage 20 defines an inner wall 22. There is a choked flow oil conduit 24 from the input oil stream 107 that comprises at least one oil transfer passage 26. The oil transfer passage 26 has a first end and a second end. The oil transfer passage 26 first end begins in the inner wall 22 and is in fluid communication with the input oil stream 107. The choked flow oil conduit further has an oil transfer channel 28. The oil transfer channel 28 has a first end and a second end, the oil transfer channel 28 first end is connected with the oil transfer passage 26 second end. The input oil stream 107 has a choked flow oil stream 113 that is diverted from the input oil stream 107 at the oil transfer passage 26 first end. The choked flow oil stream 113 flows to the oil transfer passage 26 second end where it enters the oil transfer channel 28. The diverted choked flow oil stream 113 flows from the oil transfer channel 28 first end to the second end, and then through an auxiliary filter 115 to the central oil reservoir 103.

In use, it can now be understood that the oil filter by-pass adapter is placed between an internal combustion engine block and a spin-on type primary oil filter of an oil filtration system. The thickness of the wafer does not interfere with the threaded fit of the primary oil filter to the engine block. The oil filtration system has an oil pump, a central oil reservoir, a primary oil filter, an input oil stream from the oil pump leading into the primary oil filter, and an output oil stream leading out of the primary oil filter into the engine block. The oil filter by-pass adapter diverts a choked flow oil stream to an auxiliary filter. There is a central through passage extending through the wafer plate that provides clearance for the oil stream to enter and exit the spin-on type primary oil filter. The choked flow oil stream is achieved through a choked flow oil conduit from the input oil stream that comprises an oil transfer passage and an oil transfer channel. The oil transfer passage begins in the inner wall and is in fluid communication with the input oil stream. The oil transfer channel is connected with the oil transfer passage and serves to transfer the choked flow choked flow oil stream that was diverted from the input oil stream by the oil transfer passage. The diverted choked flow oil stream flows from the oil transfer channel through an auxiliary filter and then to the central oil reservoir. While diverting a smaller volume of oil at a time than the primary oil filter, the auxiliary filter will over time filter the entire oil supply. Primary oil filters usually are designed to remove particles larger than 20 microns, and an auxiliary filter can be used that will remove particles down to 2 microns from the oil stream. This extra filtration reduces the load on the engine components during a cold start as more particles in the oil have been removed from the oil stream, thus there are fewer particle deposits left on the engine components after the oil drains back into the central oil reservoir when the engine is shut down.

While an embodiment of the oil filter by-pass adapter has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the disclosed device. For example, any suitable sturdy material such as another metal or type of plastic may be used instead of the materials described.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. An oil filter by-pass adapter for placement between an internal combustion engine block and a spin-on type oil filter of an oil filtration system, the oil filtration system comprising an oil pump, a central oil reservoir, a primary oil filter, an input oil stream from the oil pump leading into the primary oil filter, and an output oil stream leading out of the primary oil filter into the engine block, that diverts a choked flow oil stream to an auxiliary filter, the oil filter by-pass adapter comprising:
a wafer plate having an outer wall, a first face adapted to sealably contact the engine block, a second face adapted to sealably contact the spin-on type oil filter, said second face having a peripheral wall, a central through passage extending through said wafer plate from said first face to said second face providing clearance for the input oil stream to enter the spin-on type oil filter and the output oil stream to exit the spin-on type oil filter, said central through passage defining an inner wall, and
a choked flow oil conduit from the input oil stream comprising at least one oil transfer passage having a first end and a second end, said first end in fluid communication with the input oil stream, said choked flow oil conduit further comprising an oil transfer channel having a first end and a second end, said oil transfer channel first end connected with said oil transfer passage second end, wherein said oil transfer channel second end diverts an oil stream through an auxiliary filter to the central oil reservoir.

2. The oil filter by-pass adapter of claim 1 wherein said wafer plate comprises an ultra high molecular density plastic.

3. The oil filter by-pass adapter of claim 1 wherein said wafer plate comprises aluminum.

4. The oil filter by-pass adapter of claim 1 wherein said oil transfer passages are in the range of from 1/64 inches to 7/64 inches in diameter.

5. The oil filter by-pass adapter of claim 4 wherein said oil transfer passages are in the range of from 3/64 inches to 5/64 inches in diameter.

6. The oil filter by-pass adapter of claim 1 wherein said oil transfer channel is 3/64-¼ inches in diameter.

7. The oil filter by-pass adapter of claim 6 wherein said oil transfer channel is 5/64- 13/64 inches in diameter.

8. An oil filter by-pass adapter for placement between an internal combustion engine block and a spin-on type oil filter of an oil filtration system, the oil filtration system comprising an oil pump, a central oil reservoir, a primary oil filter, an input oil stream from the oil pump leading into the primary oil filter, and an output oil stream leading out of the primary oil filter into the engine block, that diverts a choked flow oil stream to an auxiliary filter, the oil filter by-pass adapter comprising:
a wafer plate having an outer wall, a first face adapted to sealably contact the engine block, a second face adapted to sealably contact the spin-on type oil filter, said second face having a peripheral wall, a central through passage extending through said wafer plate from said first face to said second face providing clearance for the input oil stream to enter the spin-on type oil filter and the output oil stream to exit the spin-on type oil filter, said central through passage defining an inner wall,
a plurality of oil transfer passages having a first end and a second end, said first end in fluid communication with the input oil stream, and
an oil transfer channel tangential to said central through passage, said oil transfer channel having a first end and a second end, said oil transfer channel first end connected with said oil transfer passage second ends, wherein said oil transfer channel second end diverts an oil stream through an auxiliary filter to the central oil reservoir.

9. The oil filter by-pass adapter of claim 8 wherein said wafer plate comprises an ultra high molecular density plastic.

10. The oil filter by-pass adapter of claim 8 wherein said wafer plate comprises aluminum.

11. The oil filter by-pass adapter of claim 8 wherein said oil transfer passages are in the range of from 1/64 inches to 7/64 inches in diameter.

12. The oil filter by-pass adapter of claim 11 wherein said oil transfer passages are in the range of from 3/64 inches to 5/64 inches in diameter

13. The oil filter by-pass adapter of claim 8 wherein said oil transfer channel is in the range of from 3/64 inches to ¼ inches in diameter.

14. The oil filter by-pass adapter of claim 13 wherein said oil transfer channel is in the range of from 3/64 inches to 9/64 inches in diameter

15. An oil filter by-pass adapter comprising:
a circular wafer plate having an outer wall, a first face and a second face, said second face having a peripheral wall,
a central through passage extending through said wafer plate from said first face to said second face, said central through passage defining an inner wall,
a plurality of oil transfer passages having a first end and a second end, said oil transfer passages extending through said first face, and
an oil transfer channel tangential to said central through passage, said oil transfer channel having a first end and a second end, wherein said oil transfer channel first end is connected with said second ends of said oil transfer passages, wherein said lateral choked flow oil conduit second end diverts a choked flow oil stream through an auxiliary filter to the central oil reservoir.

16. The oil filter by-pass adapter of claim 15 wherein said wafer plate comprises an ultra high molecular density plastic.

17. The oil filter by-pass adapter of claim 15 wherein said wafer plate comprises aluminum.

18. The oil filter by-pass adapter of claim 15 wherein said oil transfer passages are in the range of from 3/64 inches to 5/64 inches in diameter.

19. The oil filter by-pass adapter of claim 15 wherein said oil transfer channel is in the range of from 3/64 inches to 15/64 inches in diameter.

20. The oil filter by-pass adapter of claim 19 wherein said oil transfer channel is in the range of from 5/64 inches to 11/64 inches in diameter.
